(19) United States
(12) Patent Application Publication
(10) Pub. No.: US 2009/0080802 A1
(43) Pub. Date: Mar. 26, 2009

(54) INFORMATION PROCESSING APPARATUS AND METHOD FOR GENERATING COMPOSITE IMAGE

(75) Inventor: Eita Shuto, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/057,137

(22) Filed: Mar. 27, 2008

(30) Foreign Application Priority Data
Sep. 25, 2007 (JP) 2007247630

(51) Int. Cl. G06K 9/36

(52) U.S. Cl. 382/284

(57) ABSTRACT

An information processing apparatus includes: a first decoder that decodes first image data into a first image; a second decoder that decodes second image data into a second image; a third decoder that decodes third image data into a third image; a compose unit that composes, into a first area in the first image, an image of a second area of the second image, the second area having the same coordinate position as the first area; and a blend processing unit that generates a display screen no by overlapping the second image, the third image and the first image being superimposed with the second image, in order from bottom to top.

### CROSS-REFERENCE TO RELATED APPLICATIONS

This application is based upon and claims the benefit of priority from Japanese Patent Application No. 2007-247630, filed on Sep. 25, 2007, the entire content of which are incorporated herein by reference.

### BACKGROUND

1. Field

One embodiment of the invention relates to an information processing apparatus that reproduces an image is stored on an HD DVD (High Definition Digital Versatile Disk) and to a composite image generation method for reproducing and combining a plurality of images.

2. Description of the Related Art

In recent years, development of a reproducing apparatus (hereinafter, simply referred to as a “player”) capable of handling a high definition image of HD (High Definition) standard has been advanced with the progression of the digital compression coding technology of a video image.

For this kind of player, a function for composing a plurality of images in high dimensions is demanded to enhance interactivity.

For example, there is disclosed in JP-A-8-205092 a system of combining graphics data and video data by a display controller. In this system, the display controller captures video data and composes the captured video data on an area of a part of a graphics screen.

In conventional systems, including the system described in JP-A-8-205092, it is assumed that comparatively low definition video data is handled, and handling of a high definition image such as video data of the HD standard is not considered. In addition, the conventional systems are not intended for superposing a large number of images.

On the other hand, in HD DVD Video standard, it is necessary to overlap a maximum of five images where appropriate. Thus, amount of data needs to be processed arrives to such an extent that the actual processing capability is exceeded. Therefore, for the method of superposing a plurality of images on each other to generate a display screen, appropriate efficiency of decreasing the processing amount in image processing of an area where the images are superposed on each other and considering load is demanded.

### SUMMARY

According to a first aspect of the present invention, there is provided an information processing apparatus includes: a first decoder that decodes first image data into a first image; a second decoder that decodes second image data into a second image; a third decoder that decodes third image data into a third image; a compose unit that composes, into a first area in the first image, an image of a second area of the second image, the second area having the same coordinate position as the first area; and a blend processing unit that generates a display screen by overlapping the second image, the third image and the first image being superimposed with the second image, in order from bottom to top.

According to a second aspect of the present invention, there is provided a method for generating a composite image being overlapped with a first image, a second image, and a third image, in order from top to bottom, the method comprising: superimposing, into a first area in the first image, an image of a second area of the third image, the second area having the same coordinate position as the first area; and generating the composite image by overlapping the first image being superimposed with the third image, the second image, and the third image, in order from the top to the bottom.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a perspective view to show an example of the appearance of an information processing apparatus according to one embodiment of the present invention.

FIG. 2 is a block diagram to show an example of a system configuration of the information processing apparatus.

FIG. 3 is a block diagram to show the functional configuration of software decoders implemented by an HD DVD player application program shown in FIG. 2.

FIG. 4 is a conceptual drawing to show how five planes in AV content of HD standard are superposed in the information processing apparatus shown in FIG. 1.

FIG. 5 is a drawing to describe a method of performing blending processing without changing alpha data, executed in an information processing apparatus in a related art.

FIG. 6 is a drawing to describe blending processing executed by a mixer (MIX) section of the information processing apparatus in the related art.

FIG. 7 is a drawing to describe a method of performing blending processing by changing alpha data, executed in the information processing apparatus in the related art.

FIG. 8 is a drawing to describe a plane image overwrite function provided in the information processing apparatus shown in FIG. 1.

FIG. 9 is a flowchart to describe an image write section provided in the information processing apparatus shown in FIG. 1.

### DETAILED DESCRIPTION

Referring now to the accompanying drawings, there is shown an embodiment of the present invention.

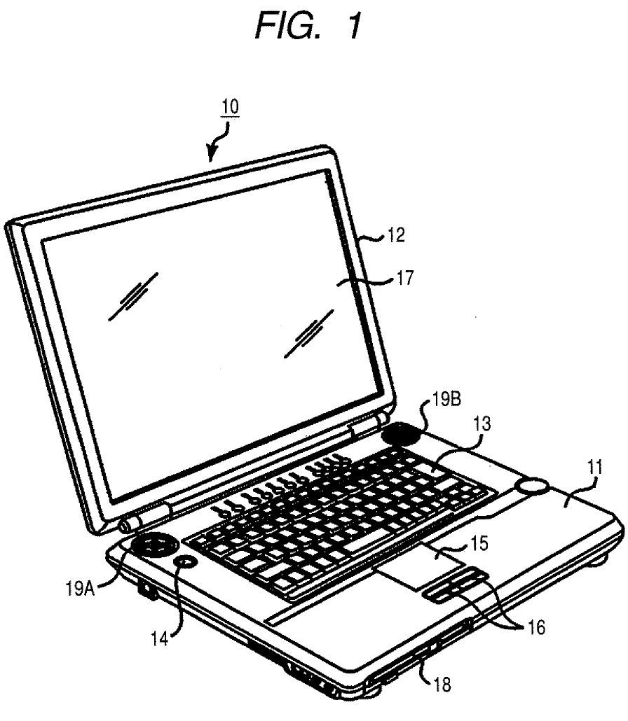

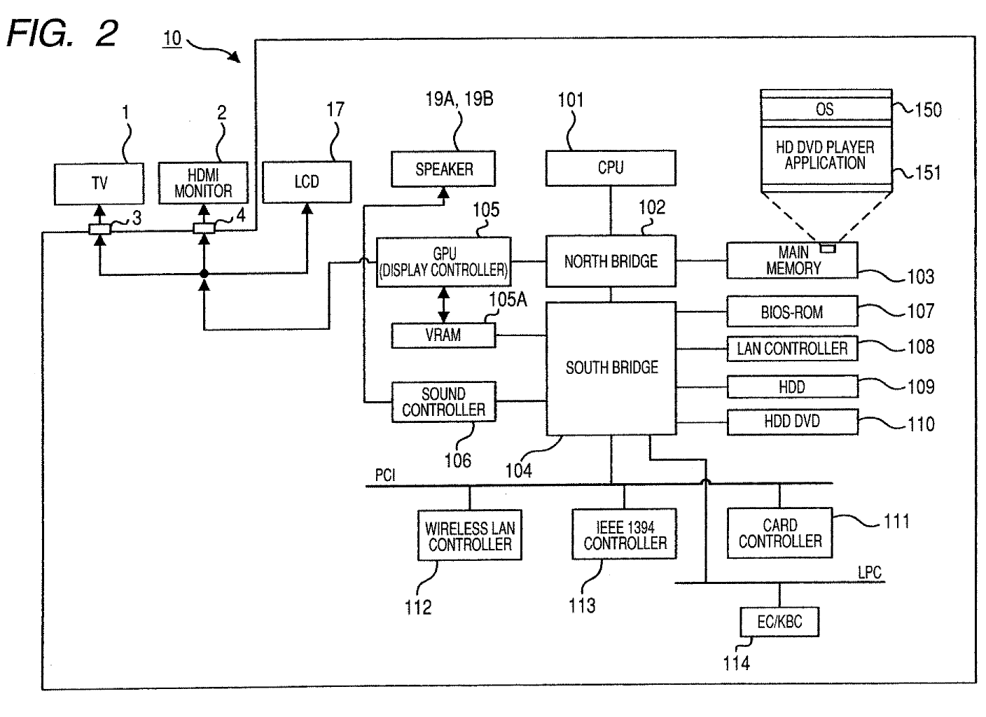

First, a configuration of an information processing apparatus according to one embodiment of the invention will be described with reference to FIGS. 1 and 2. In the embodiment, it is assumed that the information processing apparatus is implemented as a notebook personal computer 10.

FIG. 1 is a perspective view of the notebook personal computer 10 in a state in which a display unit is open. The computer 10 includes a computer main unit 11 and a display unit 12. A display implemented as a TFT-LCD (Thin Film Transistor Liquid Crystal Display) 17 is built in the display unit 12 and the display screen of the LCD 17 is positioned almost in the center of the display unit 12.

The display unit 12 is attached to the computer main unit 11 so that the display unit 12 is pivotable between an open position and a closed position. The computer main unit 11 has a thin box-shaped cabinet, and a keyboard 13, a power button 14 for turning on/off power of the computer 10, a touch pad 15, a click button 16, speakers 19A and 19B, and the like are placed on the top face of the cabinet.

The computer 10 reproduces audio/video (AV) content (of HD DVD Video standard) stored on a DVD medium of HD DVD standard. A slot 18 for inserting a DVD medium is provided on the front of the computer main unit 11.

In the embodiment, an HD DVD can be reproduced. In the HD DVD Video standard, a display screen displayed in an information processing apparatus for reproducing content includes five image planes. When blend processing of generating a display screen is performed, the superposing order of the planes is fixed; a main video plane, a subvideo plane, a subpicture plane, a graphics plane, and a cursor plane are superposed in order from the bottom to the top.

The personal computer 10 according to the embodiment has a plane image overwrite function of writing an image of the main video plane onto the subpicture plane and the graphics plane and writing an image of the subpicture plane onto the graphics plane. The plane image overwrite function is implemented as one function in a blend processing function of generating a display screen with three or more planes superposed on each other, for example. To display a main video image so that it is seen above graphics, for example, the plane image overwrite function is one of functions of writing the desired main video image onto the graphics plane, thereby displaying the image so that it is seen above graphics.

For image processing of an area where a plurality of images are superposed on each other, hitherto having been performed using only control of alpha data of a coefficient indicating the transparency of each pixel, the plane image overwrite function makes it possible to reduce the number of times of rewrite processing of the alpha data of each pixel and decrease the whole processing amount of blend processing.

FIG. 2 shows the system configuration of the personal computer 10 according to the embodiment of the invention. The computer 10 includes a CPU 101, a north bridge 102, main memory 103, a south bridge 104, a graphics processing unit (CPU) 105, video memory (VRAM) 105A, a sound controller 106, BIOS-ROM 107, a LAN controller 108, a hard disk drive (HDD) 109, an HD DVD drive 110, a card controller 111, a wireless LAN controller 112, an IEEE 1394 controller 113, and an embedded controller/keyboard controller IC (EC/KBC) 114.

The CPU 101 is a processor for controlling the operation of the computer 10 and executes an operating system (OS) 150 and various application programs such as an HD DVD player application program 151 loaded into the main memory 103 from the hard disk drive (HDD) 109. The HD DVD player application program 151 is software operating on the OS 150 and performs control to play back AV content read from the HD DVD drive 110.

The AV content stored on a storage medium such as an HO DVD medium driven by the HD DVD drive 110 includes compressed and coded main video data, compressed and coded main audio data, compressed and coded subvideo data, compressed and coded subpicture data, graphics data containing alpha data, compressed and coded subaudio data, navigation data for controlling playback of the AV content, and the like.

The compressed and coded main video data is data provided by compressing and coding a video image used as a main video (main screen image), for example, according to a compressing coding system of H.264/AVC standard. The main video data is made of a high definition image of the HD standard. Main video data of SD (Standard Definition) standard can also be used. The compressed and coded main audio data is audio data corresponding to the main video data. The main audio data is reproduced in synchronization with the main video data.

The compressed and coded subvideo data is a subvideo (subscreen image) displayed in a state in which it is superposed on the main video and is made of a video image supplementing the main video data (for example, an interview scene of a movie director, etc.,). The compressed and coded subaudio data is audio data corresponding to the subvideo data. The subaudio data is reproduced in synchronization with playback of the subvideo data.

The graphics data is also a subvideo (subscreen image) displayed in a state in which it is superposed on the main video and includes various pieces of data (Advanced Elements) to display an operation guidance like a menu object, for example. Each Advanced Element includes a still images a video image (containing animation), and text. The HD DVD player application has a drawing function of drawing a picture in accordance with mouse operation of the user. The image drawn by the drawing function is also used as the graphics data and can be displayed in a state in which it is superposed on the main video.

The compressed and coded subpicture data includes text for a caption.

The navigation data contains a play list for controlling the content playback order and a script for controlling playback of subvideo data, graphics data (Advanced Elements), etc. The script is described in a markup language such as XML (Extensible Markup Language).

The north bridge 102 is a bridge device for connecting a local bus of the CPU 101 and the south bridge 104. The north bridge 102 also contains a memory controller for controlling access to the main memory 103. The north bridge 102 also has a function of executing communications with the To GPU 105 through a serial bus of PCI EXPRESS standard, etc.

The GPU 105 is a graphics controller for generating a display screen from the data written by the CPU 101 into the video memory (VRAM) 105A allocated to a storage area of a part of the main memory 103. For example, if the CPU 101 writes images (main video, subvideo, subpicture, graphics, and cursor) onto five planes in the VRAM 105, the GPU 105 executes blend processing of superposing the images corresponding to the five planes for each pixel and generates a display screen.

The blend processing is executed using alpha data corresponding to the main video, the subvideo, the subpicture, and the graphics. The alpha data has a value in the range of to 0 and as the value approaches 0, the pixel color becomes colorless and transparent. The alpha data is stored on an HD DVD medium together with main video, subvideo, subpicture, and graphics images. That is, each of the main video, the subvideo, the subpicture, and the graphics includes an image and the alpha data.

The south bridge 104 controls devices on an LPC (Low Pin Count) bus and devices on a PCI (Peripheral Component Interconnect) bus. The south bridge 104 also contains an IDE (Integrated Drive Electronics) controller for controlling the hard disk drive (HDD) 109 and the HD DVD drive 110. Further, the south bridge 104 also has a function of executing communications with the sound controller 106.

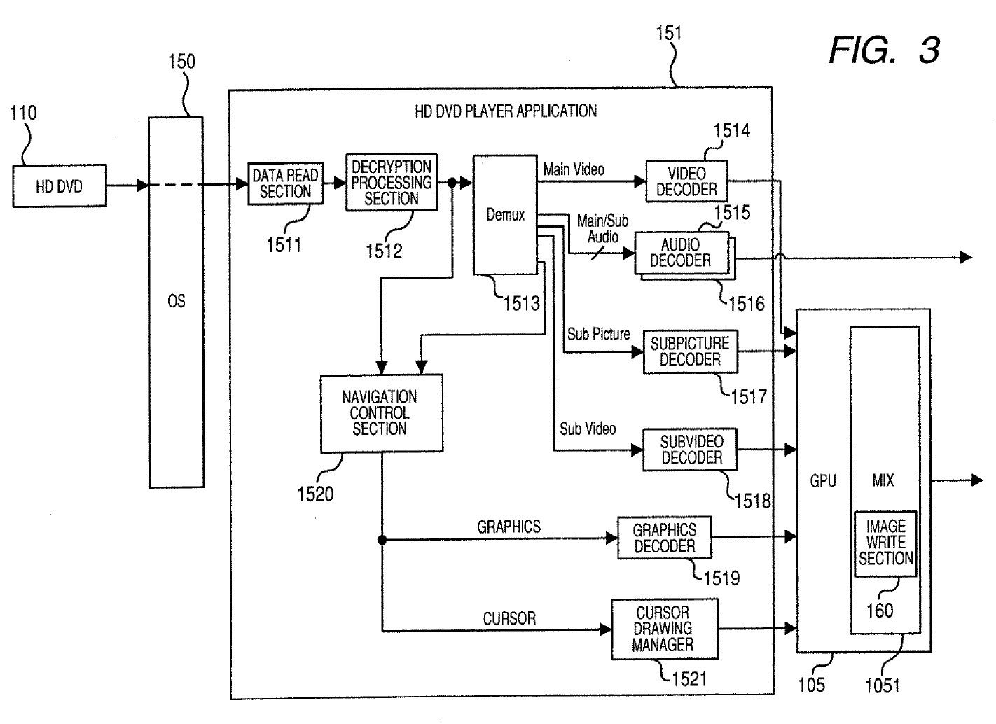

Next, the functional configuration of image processing realized by the HD DVD player application program 151 for reproducing AV content of the HD DVD Video standard will be discussed with reference to FIG. 3.

The HD DVD player application program 151 is an application program operating under the control of the operating system 150 and includes a data read section 1511, a decryption processing section 1512, a demultiplexer (Demux) section 1513, a video decoder 1514, an audio decoder 1515, a subaudio decoder 1516, a subpicture decoder 1517, a subvideo decoder 1518, a graphics decoder 1519, a navigation control section 1520, a cursor drawing manager 1521, etc., as shown in FIG. 3.

The content stored on an HD DVD medium in the HD DVD drive 110 (main video data, subvideo data, subpicture data, main audio data, subaudio data, graphics data, navigation data) is read from the HD DVD drive 110 by the data read section 1511. The main video data, the subvideo data, the subpicture data, the main audio data, the subaudio data, the graphics data, and the navigation data are encrypted. The main video data, the subvideo data, the subpicture data, the main audio data, and the subaudio data are multiplexed into an HD DVD stream. The main video data, the subvideo data, the subpicture data, the main audio data, the subaudio data, the graphics data, and the navigation data read from the HD DVD medium by the data read section 1511 are input to the decryption processing section 1512, which then executes processing for decrypting the data. The decrypted navigation data is sent to the navigation control section 1520. The decrypted HD DVD stream is sent to the demultiplexer (Demux) section 1513.

The navigation control section 1520 analyzes the script (XML) contained in the navigation data and controls reproducing the graphics data (Advanced Elements). The graphics data (Advanced Elements) is sent to the graphics is decoder 1519, which then decodes the graphics data. The navigation control section 1520 executes processing of moving the cursor in accordance with mouse device operation of the user. Image drawing of the drawing function is realized as the navigation control section 1520 acquires mouse device operation of the user and the GPU 105 generates graphics data of a picture provided according to the path of the mouse device operation, namely, the cursor path and then the graphics data is again input to the GPU 105 as graphics data equivalent to graphics data based on navigation data decoded by the graphics decoder 1519.

The demultiplexer (Demux) section 1513 demultiplexes the HD DVD stream into the main video data, the main audio data, the subaudio data, the subpicture data, the subvideo data, etc.

The main video data is sent to and decoded by video decoder 1514.

The main audio data is sent to and decoded by the audio decoder 1515. The subaudio data is sent to and decoded by the subaudio decoder 1516. The decoded main audio data and subaudio data are sent to an audio mixer (not shown) as a digital audio signal in an I2S format.

The subpicture data and the subvideo data are sent to and decoded by the subpicture decoder 1517 and the subvideo decoder 1518 respectively.

The decoded main video data, subpicture data, subvideo data, and graphics data are written into the VRAM 105A by the CPU 101 as a main video plane, a subpicture plane, a subvideo plane, and a graphics plane respectively. Cursor data corresponding to a cursor image is also written into the VRAM 105A as a cursor plane. Each of the main video data, the subpicture data, the subvideo data, the graphics data, and the cursor data contains alpha data for each pixel.

The GPU 105 composes (overlaps) the images in the main video plane, the subvideo plane, the graphics plane, the subpicture plane, and the cursor plane in the VRAM 105A to generate a display screen. In this case, the five plane images are superposed for each pixel as a mixer (MIX) section 1051 of the GPU 105 executes blend processing.

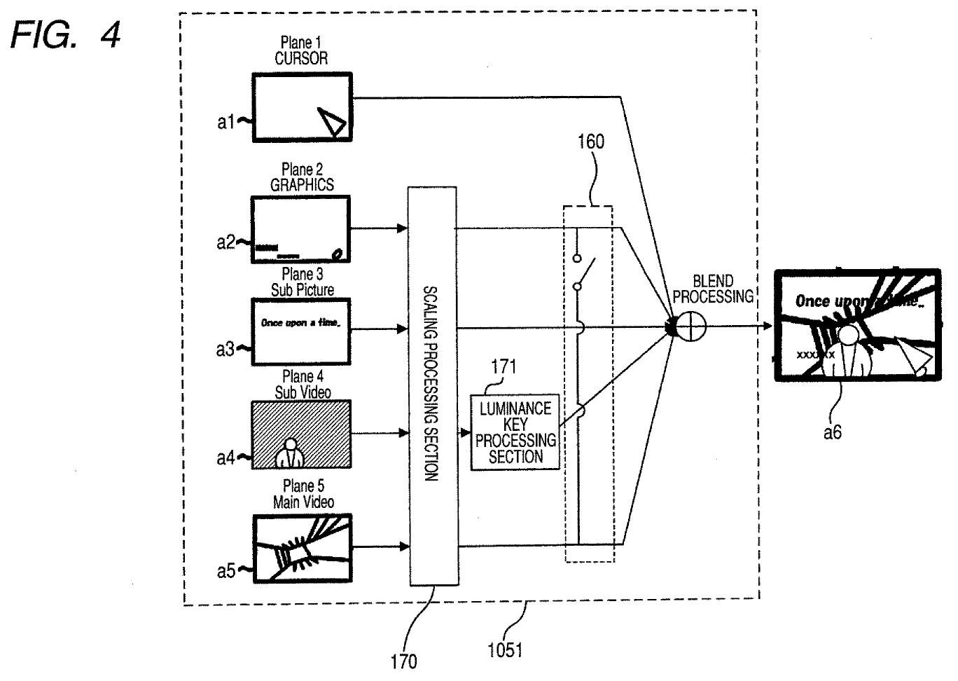

The mixer (MIX) section 1051 executes blend processing based on the alpha data corresponding to each of the five plane images, the position information each of the five plane images specified by the CPU 101, and the plane image overwrite function of an image write section 160 described later with reference to FIG. 4, etc., thereby superposing the main video, the subvideo, the graphics, the subpicture, and the cursor on a background image of 1920×1080 pixels, for example, to generate a display screen.

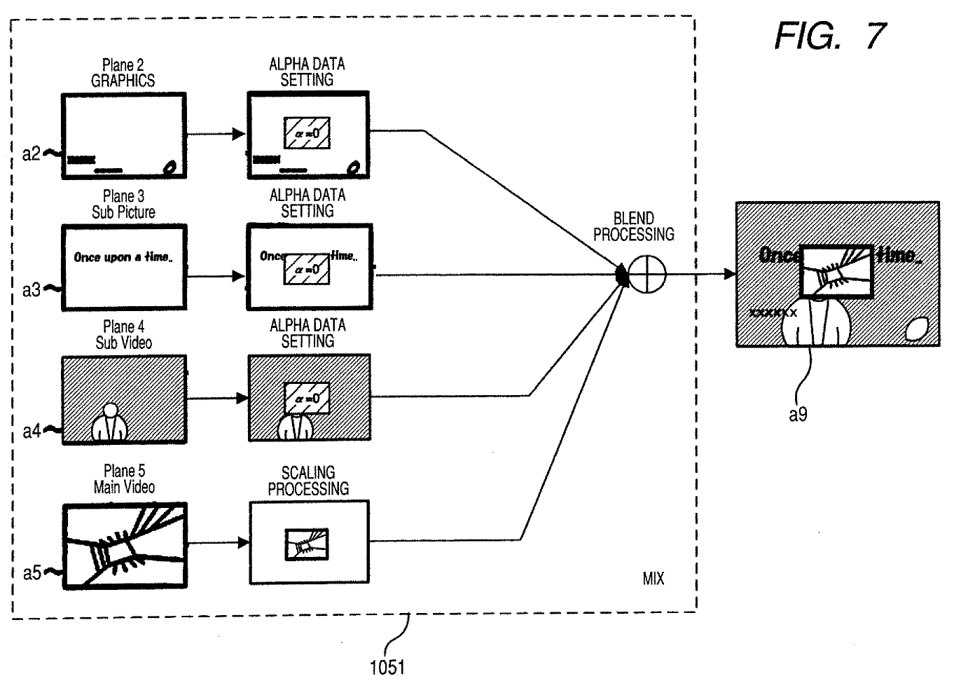

FIG. 4 is a conceptual drawing to show a procedure of the blend processing of superposing a plurality of pieces of image data in AV content of the HD standard reproduced by the personal computer 10 according to the embodiment of the invention. In the example in FIG. 4, plane image overwrite of the image write section 160 is not performed. Processing wherein the image write section 160 performs plane image overwrite is described later with reference to FIG. 7.

In the HD DVD Video standard, five planes of planes 1 to 5 are defined and are assigned the cursor, the graphics, the subpicture, the subvideo, and the main video described above respectively. In the embodiment, the mixer (MIX) section 1051 of the GPU 105 composes five images (a1 to a5) of planes 1 to 5 to create a target image a6, as shown in FIG. 4.

The CPU 105 has a scaling processing section 170 and a luminance key processing section 171 in addition to the mixer (MIX) section 1051. The scaling processing section 170 executes scaling processing of scaling up and down the resolution of an image stepwise. The luminance key processing section 171 executes luminance key processing of removing a background (black) in an image by setting the alpha value of a pixel with the luminance value less than a threshold value to 0.

In the embodiment, as shown in FIG. 4, the scaling processing section 170 performs scaling processing for the images a2 to a5 of planes 2 to 5. The luminance key processing section 171 performs luminance key processing for the image a4 of plane 4.

The embodiment has the plane image overwrite function of writing an image of the main video plane onto the graphics plane and the subpicture plane and writing an image of the subpicture plane onto the graphics plane. The plane image overwrite function is implemented as one of graphics menu objects, for example, and is started for displaying scaled small main video (which will be hereinafter referred to as window) on a background screen with subpicture, subvideo, and graphics menu as the background screen, for example. The plane image overwrite function is executed by the image write section 160 in the mixer (MIX) section 1051, for example.

For image processing of an area where a plurality of images are superposed on each other, hitherto having been performed using only control of alpha data of each pixel, the plane image overwrite function makes it possible to reduce the processing amount of rewriting the alpha data of each pixel, thereby decreasing the whole processing amount of the blend processing. The plane image overwrite function is described below in detail:

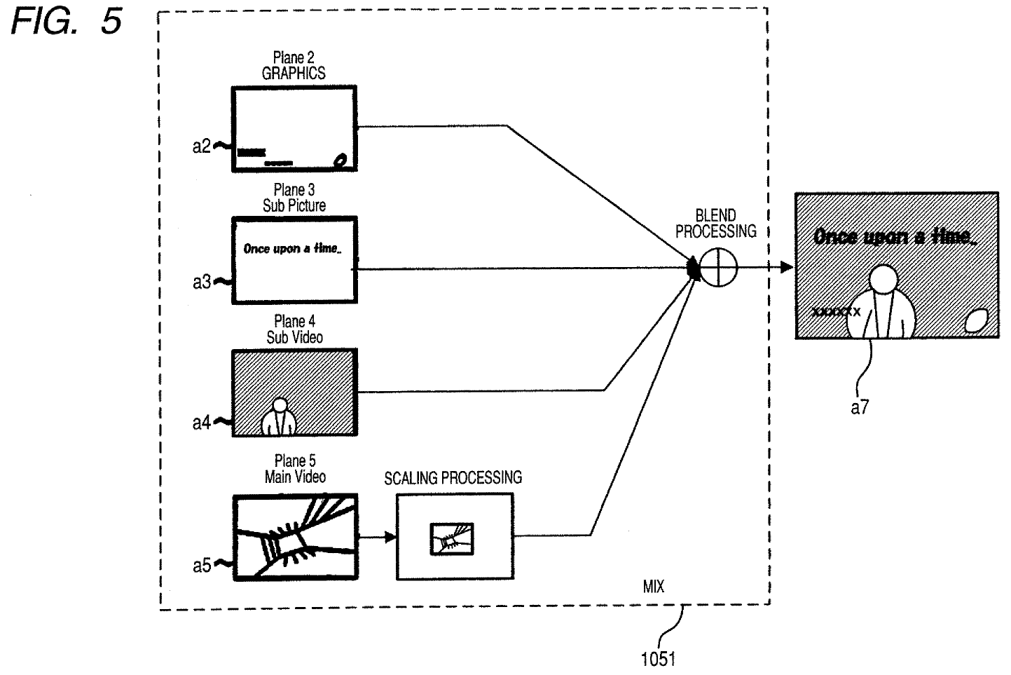

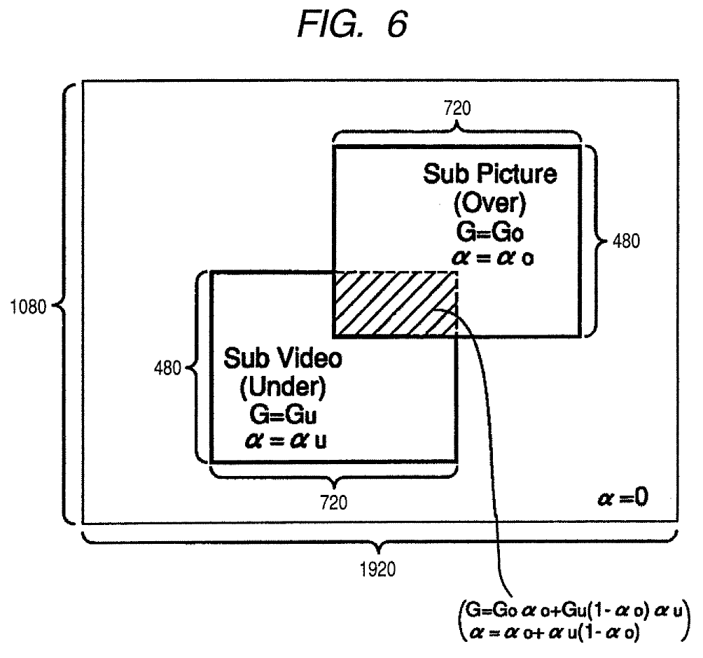

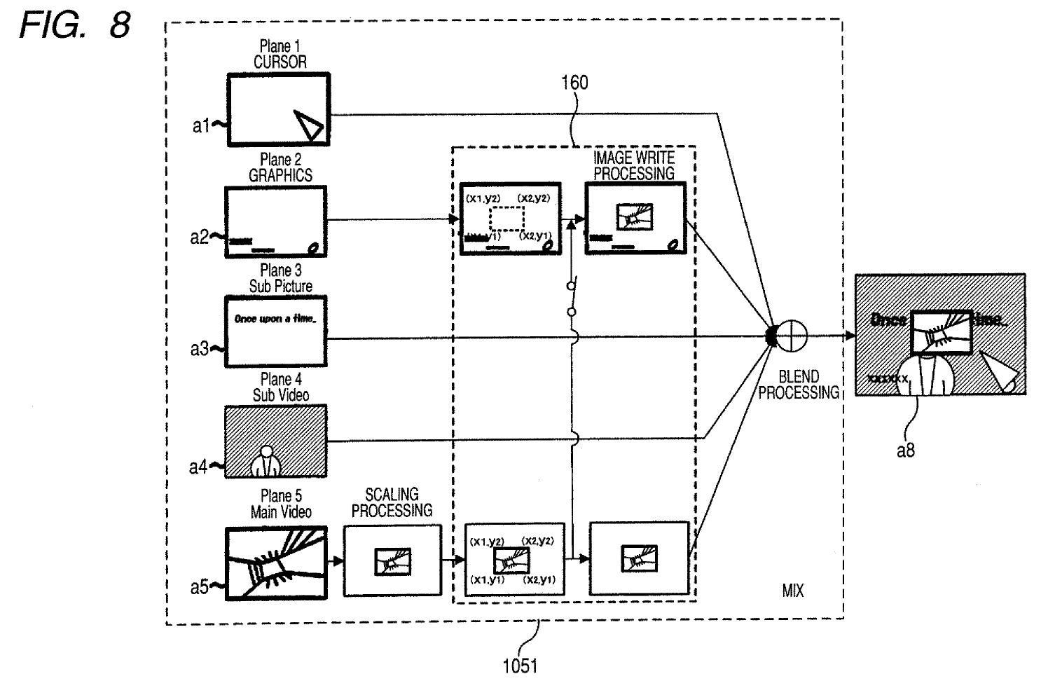

To begin with, the image processing of an area where a plurality of images are superposed on each other, hitherto having been performed using only control of alpha data of each pixel will be discussed with reference to FIGS. 5 to 7 and then the plane image overwrite function used to generate a display screen with a plurality of planes superposed on each other in the embodiment will be discussed with FIG. 8. In FIGS. 5 and 7, for easy understanding of the technical description, the target is narrowed to the four planes of the main video plane, the subvideo plane, the subpicture plane, and the graphics plane.

FIG. 5 shows the case where blend processing is performed for the four planes in a state in which the alpha data value of each pixel is set to 1 and alpha data control is not performed. Further, the case where a subpicture is displayed on a full screen as a background screen and main video is scaled down by scaling processing for display is assumed. If the alpha data value of each pixel is 1, an image made up of the pixels becomes opaque. In the HD DVD Video standard, the superposing order of the planes in the blend processing function is fixed and therefore the images displayed in the planes are superposed on each other in the order of the main video plane, the subvideo plane, the subpicture plane, and the graphics plane from the bottom to the top to generate a display screen a7.

For example, to use subpicture, subvideo, and graphics menu as a background screen and display a window of main video on the background screen, in a related art, a method of setting the values of alpha data in specific areas of the three planes superposed over the main video plane are set to 0 is possible.

The blend processing based on the alpha data, executed by the mixer (MIX) section 1051 of the GPU 105 will be discussed.

For example, the case where a display screen having a resolution of 1920×1080 pixels is generated from the subpicture plane and the subvideo plane scaled down by scaling processing is assumed. Each of the subpicture plane and the subvideo plane has a resolution of 720×480 pixels, for example. In this case, alpha data of a resolution of 720×480 pixels is also added to each of the subpicture plane and the subvideo plane.

For example, if the subpicture plane is used as an over surface and the subvideo plane is used as an under surface, the color of each pixel in the superposition area of the subpicture plane and the subvideo plane is found according to the following expression (1):

G=Go×αo+Gu(1−αuo)αu (1)

In the expression (1), G is the color of each pixel in the superposition area, Go is the color of each pixel of the subpicture plane used as an over surface, αo is the alpha value of each pixel of the subpicture plane used as an over surface, and Gu is the color of each pixel of the subvideo plane used as the under surface.

The alpha value of each pixel in the superposition area of the subvideo plane and the subpicture plane is found according to the following expression (2):

α=αo+αu×(1−αo) (2)

In the expression (2), α is the alpha value of each pixel in the superposition area and αu is the alpha value of each pixel of the main video data used as an under surface.

Thus, the mixer (MIX) section 1051 uses the alpha data used as the over surface, of the alpha data corresponding to the subpicture plane and the subvideo plane to overlap the subpicture plane and the subvideo plane, thereby generating a display screen of 1920×1080 pixels. Further, the mixer (MIX) section 1051 calculates the alpha value of each pixel of the display screen of 1920×1080 pixels from the alpha data corresponding to the subpicture plane and the alpha data corresponding to the subvideo plane.

The above-mentioned method of setting the values of alpha data to 0, thereby displaying a window of main video on a background screen with subpicture, subvideo, and graphics menu as the background screen will be discussed below briefly with reference to FIG. 7.

This method is a method of rewriting the values of the alpha data of the pixels making up each of the window areas of the subvideo plane, the subpicture plane, and the graphics plane to 0 as shown in FIG. 7. For example, the mixer (MIX) section 1051 performs the blend processing including rewriting of the alpha data. When the values of the alpha data of the pixels making up each of the window areas of the planes are set to 0, the window areas in the subvideo plane, the subpicture plane, and the graphics plane become colorless and transparent and a display screen a8 is displayed with the desired window seen through the window areas.

However, in the method shown in FIG. 7, to perform the blend processing, it is necessary to process the alpha data of the window areas in the subvideo plane, the subpicture plane, and the graphics plane, and the processing amount in the blend processing increases. Since the menu object subjected to alpha data processing is temporarily retained in the process of rewriting the alpha data of menu objects on the graphics plane, a buffer dedicated to the graphics plane (not shown) becomes necessary.

Then, in the embodiment, a decrease in the processing amount in the blend processing is accomplished by using the plane image overwrite function. In the embodiment, the plane image overwrite function is executed by the image write section 160 in the mixer (MIX) section 1051, for example. To display the main video window so that the main video window is seen under the cursor plane and over the subvideo plane, the subpicture plane, and the graphics plane as shown in FIG. 8, the plane image overwrite function is a function of writing an image of the main video window into the window area of the graphics plane positioned in the same coordinates as the main video window (in the example in FIG. 8, rectangular area surrounded by (x1, y1), (x1, y2), (x2, y2), (x2, y1)). In the embodiment, to perform the blend processing, image write processing is performed only for one plane in the process of generating the display screen a8 where the desired window can be seen, and the whole processing amount of the blend processing becomes one-third of the processing amount involved in the method shown in FIG. 7.

In the embodiment, in addition to writing the main video window into the graphics plane, the main video window can also be written into the subpicture plane and the subvideo window can also be written into the graphics plane. In this case, the processing amount of the blend processing becomes a half of the processing amount involved in the method shown in FIG. 7.

In the description of the embodiment, the display screen in the HO DVD Video standard is taken as an example, but the invention is not limited to it. An apparatus having the blend processing function of generating a display screen with a plurality of images superposed on each other would be able to accomplish efficient blend processing using the plane image overwrite function. A window can also be written into the top image in the process of generating the display screen as with the cursor in the embodiment.

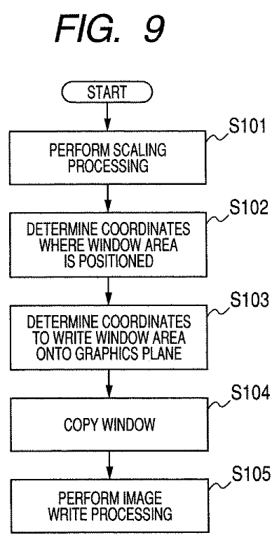

Next, a flow of the plane write function by the image write section 160 in the embodiment will be discussed with reference to FIG. 9. FIG. 9 is a flowchart to show the procedure of the plane image overwrite function executed by the image write section 160 in the embodiment, for example. Here, the case where an image of the main video plane is written into the graphics plane will be discussed, but it is assumed that the plane image overwrite function also operates according to a similar procedure for the case where an image of the main video plane is written into the subpicture plane and the case where an image of the subvideo plane is written into the graphics plane.

If the user prefers to display the main video window on a background image made up of subvideo and graphics menu, for example, the plane image overwrite function is started in the process of selecting and operating a display screen operation function of scaling, etc., provided as a graphics menu objection function, for example.

The scaling processing section 170 performs scaling processing to produce scale down display of main video (step S101).

Next, the mixer (MIX) section 1051 determines the coordinate position of the scaled main video widow area (step S102). The coordinate position of the video widow area corresponds to the rectangular area surrounded by (x1, y1), (x1, y2), (x2, y2), (x2, y1) in the example shown in FIG. 8. Further, the mixer (MIX) section 1051 determines a window area in the graphics plane based on the coordinates obtained at step S102 (step S103).

Next, the image write section 160 copies the main video window (step S104). The image write section 160 writes the copied main video window into the window area in the graphics plane determined at step S103 (step S105).

After the image write section 160 performs processing of the plane image overwrite function, the mixer (MIX) section 1051 composes the main video plane, the subvideo plane, and the graphics plane to generate a display screen.

According to the plane image overwrite function, in the embodiment, image write processing is performed only for one plane without performing rewrite processing of the values of the alpha data of the pixels making up each image for a plurality of planes, hitherto having been performed in the process of generating the display screen where the desired window can be seen by performing the blend processing, and the whole processing amount of the blend processing becomes one-third of the processing amount involved in the method in the related art if the main video window is written into the graphics plane or a half of the processing amount involved in the method in the related art if the subvideo window is written into the graphics plane.

In the method in the related art, a buffer dedicated to the graphics plane becomes necessary to temporarily retain the menu object subjected to alpha data processing in the process of rewriting the alpha data of menu objects on the graphics plane; in the embodiment, however, the buffer dedicated to the graphics plane is not required.

As described above, in the embodiment, efficient blend processing of superposing images on each other can be accomplished. As efficient blend processing is accomplished, speeding up of data transfer and playback processing can be realized. In the description of the embodiment, the display screen in the HD DVD Video standard is taken as an example, but the invention is not limited to it. An apparatus having the blend processing function of generating a display screen with a plurality of images superposed on each other would be able to accomplish efficient blend processing using the plane image overwrite function.

It is to be understood that the present invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. An information processing apparatus comprising:
a first decoder that decodes first image data into a first image;
a second decoder that decodes second image data into a second image;
a third decoder that decodes third image data into a third image;
a compose unit that composes, into a first area in the first image, an image of a second area of the second image, the second area having the same coordinate position as the first area; and
a blend processing unit that generates a display screen by overlapping the second image, the third image and the first image being superimposed with the second image, in order from bottom to top.

2. The apparatus according to claim 1 further comprising a fourth decoder that decodes fourth image data into a fourth image,
wherein the blend processing unit generates the display screen by overlapping the fourth image, the second image, the third image, and the first image being superimposed with the second image, in order from the bottom to the top.

3. The apparatus according to claim 1 further comprising a fourth decoder that decodes fourth image data into a fourth image,
wherein the blend processing unit generates the display screen by overlapping the second image, the third image, the fourth image, and the first image being superimposed with the second image, in order from the bottom to the top.

4. The apparatus according to claim 2, wherein the first decoder decodes coded graphics data for displaying an operation guidance into the first image,
wherein the second decoder decodes coded subvideo data for displaying a subvideo into the second image,
wherein the third decoder decodes coded subpicture data for displaying a caption into the third image, and
wherein the fourth decoder decodes coded main video data for displaying a main video into the fourth image.

5. The apparatus according to claim 3, wherein the first decoder decodes coded graphics data for displaying an operation guidance into the first image,
wherein the second decoder decodes coded main video data for displaying a main video into the second image,
wherein the third decoder decodes coded subvideo data for displaying a subvideo into the third image, and
wherein the fourth decoder decodes coded subpicture data for displaying a caption into the fourth image.

6. The apparatus according to claim 2 further comprising a cursor image generator that generates a cursor image for displaying a cursor,
wherein the blend processing unit generates the display screen by overlapping the fourth image, the second image, the third image, the first image being superimposed with the second image, and the cursor image, in order from the bottom to the top.

7. The apparatus according to claim 2 further comprising a cursor image generator that generates a cursor image for displaying a cursor,
wherein the blend processing unit generates the display screen by overlapping the second image, the third image, the fourth image, the first image being superimposed with the second image, and the cursor image, in order from the bottom to the top.

8. The apparatus according to claim 1, wherein the compose unit composes by copying the image the image of the second area of the second image onto the first area in the first image.

9. A method for generating a composite image being overlapped with a first image, a second image, and a third image, in order from top to bottom, the method comprising:
superimposing, into a first area in the first image, an image of a second area of the third image, the second area having the same coordinate position as the first area; and
generating the composite image by overlapping the first image being superimposed with the third image, the second image, and the third image, in order from bottom to top.
